(19) United States
(12) Patent Application Publication
(10) Pub. No.: US 2007/0036128 A1
(43) Pub. Date: Feb. 15, 2007

(54) Communication terminal and communication method

(75) Inventor: Yasuhiro Mori, Izumi-shi (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 10/568,179

(22) PCT Filed: Jan. 25, 2005
(86) PCT No.: PCT/JP05/00912

§ 371 Date: Feb. 13, 2006

(30) Foreign Application Priority Data
Feb. 9, 2004 (JP) 2004-032321

(51) Int. Cl. H04L 12/66

(52) U.S. Cl. 370/352; 455/406

(57) ABSTRACT

The present invention provides a communications terminal in which feelings which arise spontaneously can be actively communicated to a partner. Communications terminals (30a) and (30b) communicate with a partner terminal via a transmission line (90), and include: an input unit (31), which receives a finger operation including tapping; a packet generating unit (32), which generates a packet which is data describing an action that is a motion to be executed by a partner terminal, based on the received operation; a transmission unit (33), which sends the generated packet to the partner terminal; a receiving unit (11), which receives the sent packet; and an action executing unit (22), which executes an action described in the received packet.

### TECHNICAL FIELD

The present invention relates to a communication terminal and communication method for communicating with a partner terminal through a transmission line.

### BACKGROUND ART

In 2002, the number of cellular phones circulating domestically in Japan exceeded 40 million, and 70% of those were models with integrated cameras. According to a user survey, the top 5 subjects photographed with a cellular phone camera are: a friend's face; the user's own face; a landscape; a pet; and a child's face.

Therefore, a user accumulates large amounts of Digital Still Pictures (hereinafter, also referred to as DSP) received through a network as well as DSP taken by him/herself. The user can then use these DSP as a standby screen, reproduce them as a slideshow, and the like.

Incidentally, while various objects are provided as means to customize a cellular phone, the most popular means among them is the modification of a sound which indicates an incoming call, best represented by ringtones or ringsongs. A user obtains music data provided at cost/no cost by a variety of websites, sets it as the incoming signal sound, and thus customizes the cellular phone. It is also possible for the recipient side to set differing music for each originator. By the same token, altering the color and flash pattern of an LED is another means to indicate an originator.

Additionally, the alteration of the aforementioned standby screen is another customization in cellular phones. The DSP set as a standby screen is selected based on the user's preference, and may be a photograph of the user's family, a photograph of a sweetheart, and so on. Looking at the photograph displayed in the LCD strengthens feelings toward that person.

Conventionally, there is a device which exchanges mutual existence information and builds up the sense of connection between both parties by transmitting movement or noise arising from such movement using sensors equipped in the respective terminals (for example, see Patent Reference 1). Through this device, the user can know the partner's existence information without physically seeing that partner.

Patent Reference 1: Japanese Laid-Open Patent Application No. 2002-307338 (Section 1, FIG. 1)

### DISCLOSURE OF INVENTION

Problems that Invention is to Solve

However, the conventional communications terminal has the problems listed hereafter.

(1) First, while it is possible to set ringtones and ringsongs so that a different song is set for each originator, those settings must actively be set by the user for each originator. Therefore, if there are 100 originators, settings must be executed 100 times. In actuality, the number of reproducible songs that can be registered is limited, so nothing as extreme as executing settings 100 times will happen, but the fact remains that a user must register a song for each originator. This is extremely troublesome and disagreeable operation.

On the other hand, the large amounts of DSP exchanged between users over a network are, except when used as a standby screen, for the most part unused. The user carries large amounts of DSP in the cellular phone, but aside from enjoying a digital picture story-board as a slideshow, does not actively use the DSP.

Furthermore, regardless of what kind of photograph is displayed as the standby screen, that display has no relation to communications. Therefore, when a user wants to communicate with the person shown in the photograph, one must follow steps such as “first, search the address list, and next, establish communications,” which is extremely troublesome.

(2) Second, the sense-of-connection communications proposed by the conventional technology exchanges one another's existence information, and while this existence information produces a sense of security, it does not actively communicate feelings for a partner which arise spontaneously. Because such emotions cannot be put into words or letters, or are not things that are formal enough to put into words or letters, they do not fit well with communication based in conventional voice conversations or e-mail, and thus a new communications means is necessary.

In other words, the first problem with conventional technology is that associating files such as music, images, and the like with originators is intricate and difficult.

Additionally, the second problem with conventional technology is that establishing communications with a partner terminal is difficulty so actively communicating feelings which arise spontaneously to a partner is difficult.

Accordingly, a first object of the present invention is to provide a communications terminal which allows files such as music, images, and the like to be simply and easily associated with originators.

Additionally, a second object of the present invention is to provide a communications terminal in which establishing communications with a partner terminal is easy, and it is possible to actively communicate feelings which arise spontaneously to a partner.

### MEANS TO SOLVE THE PROBLEMS

A communications terminal according to the present invention is a communications terminal which communicates with a partner terminal via a transmission line, and may include: a folder unit, which has a plurality of folders that are information recording domains and which are respectively associated with a plurality of originators; an e-mail receiving unit, which receives an e-mail attached with a file that is additional information; an e-mal originator isolating unit, which isolates an originator of a received e-mail; and a storage unit that stores the file in the folder associated with the isolated originator.

Through this, a step-by-step process of storing a file attached to a received e-mail in a folder corresponding to a specified originator can be omitted. Therefore, in the case where there is an incoming signal via a transmission line from a partner terminal, easily reading out a file from a folder corresponding to the originator becomes possible.

In addition, the communications terminal according to the present invention may further include: an incoming signal detection unit, which detects an incoming signal; a caller isolating unit, which isolates the caller indicated by the detected incoming signal; and a display unit, which reads out a file stored in the folder that corresponds to the isolated originator and displays the file in a screen.

Through this, it is possible to know who a originator is from a file displayed on the screen.

In addition, in the communications terminal according to the present invention, the file may include an image file that indicates an image, and the display unit may read out a plurality of image files from the folder and display a video made up of the plurality of image files read out.

Through this, it is possible to easily know who the originator is from an image file displayed on the screen.

In addition, in the communications terminal according to the present invention, the folder may include a photograph file indicating a photograph in which the originator corresponding to the folder is shown, and the display unit may read out the photograph file from the folder and display the read-out photograph file.

Through this, it is possible to know easily and with certainty who a originator is from a photograph file indicating a photograph taken by the originator which is displayed on the screen.

In addition, the communications terminal according to the present invention is a communications terminal which communicates with a partner terminal via a transmission line, and includes: an input unit which accepts a finger operation including tapping; a packet generating unit which generates a packet which is data describing an action that is a procedure to be executed by a partner terminal, based on the received operation; a transmission unit which transmits the generated packet to the partner terminal; a receiving unit which receives the sent packet; and an action executing unit which executes the action described in the received packet.

Through this, communications are established with a partner terminal, and actions corresponding to a finger operation, including tapping, are executed in the partner terminal, so feelings which arise spontaneously can be more actively communicated to a partner, even without taking steps of searching an address book and then establishing communications.

In addition, in the communications terminal according to the present invention, in the case where the operation is an operation in which a screen is tapped consecutively, the packet generating unit may generate a packet describing an action in which a plurality of pictures are displayed in a screen while being switched, and the action executing unit may display in a screen a plurality of pre-stored pictures while switching the pictures, when the packet is received.

Through this, feelings which arise spontaneously can be more actively communicated to a partner by displaying on the screen a plurality of images while switching the images.

In addition, in the communications terminal according to the present invention, in the case where the operation is an operation in which a screen is swept, the packet generating unit may generate a packet describing an action in which a picture is panned in the swept direction, and the action executing unit may display in the screen a pre-stored picture while panning the picture in the assigned direction, when the packet is received.

Through this, feelings which arise spontaneously can be more actively communicated to a partner by causing an image to be displayed on the screen while panning in a designated direction.

In addition, in the communications terminal according to the present invention, in the case where the operation is an operation in which a circle is drawn on a screen, the packet generating unit may generate a packet describing an action in which a picture is displayed while being rotated, and the action executing unit may display in the screen a pre-stored picture while causing the picture to rotate, when the packet is received.

Through this, feelings which arise spontaneously can be more actively communicated to a partner by causing an image to be rotated while causing it to be displayed on the screen.

In addition, in the communications terminal according to the present invention, in the case where the operation is an operation in which a screen is tapped once, the packet generating unit may generate a packet describing an action in which a ripple image is displayed superimposed on a picture, and the action executing unit may display in the screen a pre-stored picture superimposed with the ripple image, when the packet is received.

Through this, feelings which arise spontaneously can be more actively communicated to a partner by causing an image superimposed with a ripple image to be displayed on the screen.

In addition, in the communications terminal according to the present invention, in the case where the operation is an operation in which one part of a displayed picture of a person is tapped, the packet generating unit may generate a packet describing an action in which the human picture is displayed with one part moved, and the action executing unit may display in the screen a pre-stored human picture in which one part is moved, when the packet is received.

Through this, feelings which arise spontaneously can be more actively communicated to a partner by moving one part of an image of a person, as in, for example, a wink, a smile, a blown kiss, and the like, and causing it to be displayed on the screen.

In addition, in the communications terminal according to the present invention, in the case where the operation is an operation in which a screen is tapped n times, the packet generating unit may generate a packet describing an action in which a video image made up of n photograph pictures is displayed, and the action executing unit may display in the screen the video image made up of n pre-stored photographs, when the packet is received.

Through this, feelings which arise spontaneously can be more actively communicated to a partner by causing a moving picture to be displayed on the screen.

In addition, in the communications terminal according to the present invention, the picture may be a picture showing a sender that has sent the packet.

Through this, feelings which arise spontaneously can be more actively communicated to a partner by causing an image showing the originator to be displayed on the screen.

In addition, in the communications terminal according to the present invention, in the case where the operation is a predetermined operation, the packet generating unit may generate a packet describing an action in which a photograph is taken and returned, and the action executing unit may include an imaging unit, and when the packet is received, said imaging unit may take a photograph and return the photograph to the partner terminal from which the packet was sent.

Through this, it is possible for the operating user to see a video image of a communications partner without interrupting the work, etc, of the partner, and feelings which arise spontaneously can be more actively communicated to a partner.

Note that the present invention can be realized not only as this kind of communications terminal, but can also be realized as a communications method having steps of the characteristic means included in this kind of communications terminal, or a program which causes a computer to execute those steps. It goes without saying that such a program can be distributed via a transmission medium, like the Internet, etc, or a storage medium, like a CD-ROM, etc.

### EFFECTS OF THE INVENTION

As has been made clear by the above descriptions, with the communications terminal according to the present invention, a step-by-step process of storing a file attached to a received e-mail in a folder corresponding to a predetermined originator can be omitted. Therefore, in the case where there is an incoming signal from a partner terminal via a transmission line, easily reading out a file from a folder corresponding to the originator becomes possible.

In addition, communications are established with a partner terminal, and actions responding to a finger operation, including tapping, are executed in the partner terminal, so feelings which arise spontaneously can be more actively communicated to a partner, even without taking steps of searching an address book and then establishing communications.

Therefore, in the present invention, effective use of files which were dead stock becomes possible, so the practical value of the present invention in today's world, where communications terminals such as cellular phones have spread, is very high.

### BRIEF DESCRIPTION OF DRAWINGS

FIG. 1 is a diagram showing the overall configuration of a communications system 1 in the first embodiment of the present invention.

FIG. 2 is a block diagram showing a function configuration of the communications terminal as indicated in FIG. 1.

FIG. 3 is a diagram showing a configuration example of an address book 15 as indicated in FIG. 2.

FIG. 4 is a flowchart showing a DSP storage processing executed in the case where an e-mail with a DSP attached is received.

FIG. 5 is a flowchart showing incoming signal processing executed in the case where an e-mail is received.

FIG. 6 is a block diagram showing a function configuration of other communications terminals 20a and 20b.

FIG. 7 is a diagram showing a configuration example of object information.

FIG. 8 is a diagram showing an overall configuration of a communications system 2 in the third embodiment of the present invention.

FIG. 9 is a block diagram showing a function configuration of communications terminals 30a and 30b as indicated in FIG. 8.

FIG. 10 is a diagram showing another configuration example of an operation-action conversion table.

FIG. 11 is a flowchart showing action packet communications processing for realizing sense-of-connection communications carried out between the communications terminals 30a and 30b.

FIG. 12 is a diagram showing a communications sequence in the sense-of-connection communications carried out between communications terminals 30a and 30b.

FIG. 13 is a diagram showing a communications sequence in the sense-of-connection communications carried out between communications terminals 30a and 30b in the case where the communications terminal 30a is tapped three times, and the communications terminal 30b is tapped once.

FIG. 14 is a diagram showing another configuration example of an operation-action conversion table.

FIG. 15 is a diagram showing a communications sequence in the sense-of-connection communications carried out between communications terminals 30a and 30b.

FIG. 16 is a diagram showing a function configuration of communications terminals 40a and 40b used in a communications system in the fourth embodiment of the present invention.

FIG. 17 is a diagram showing still another configuration example of an operation-action conversion table.

FIG. 18 is a diagram showing a communications sequence in the sense-of-connection communications carried out between communications terminals 40a and 40b.

### NUMERICAL REFERENCES

1, 2 communications system
10a, 10b,
20a, 20b,
30a, 30b,
40a, 40b communications terminal
11 incoming signal unit
12 application activating unit
13 short film generating/reproducing unit
14 display unit
15 address book
16 memory unit
17 image acquiring unit
18 face detecting unit
19 face recognizing unit
21 packet analyzing unit
22 action executing unit
31 input unit
32 packet generating unit
33 packet sending unit
41 photographing unit
90 network
191 object information
321 operation-action conversion table

### BEST MODE FOR CARRYING OUT THE INVENTION

A communications terminal according to the embodiment of the present invention is explained in detail using the diagrams.

### First Embodiment

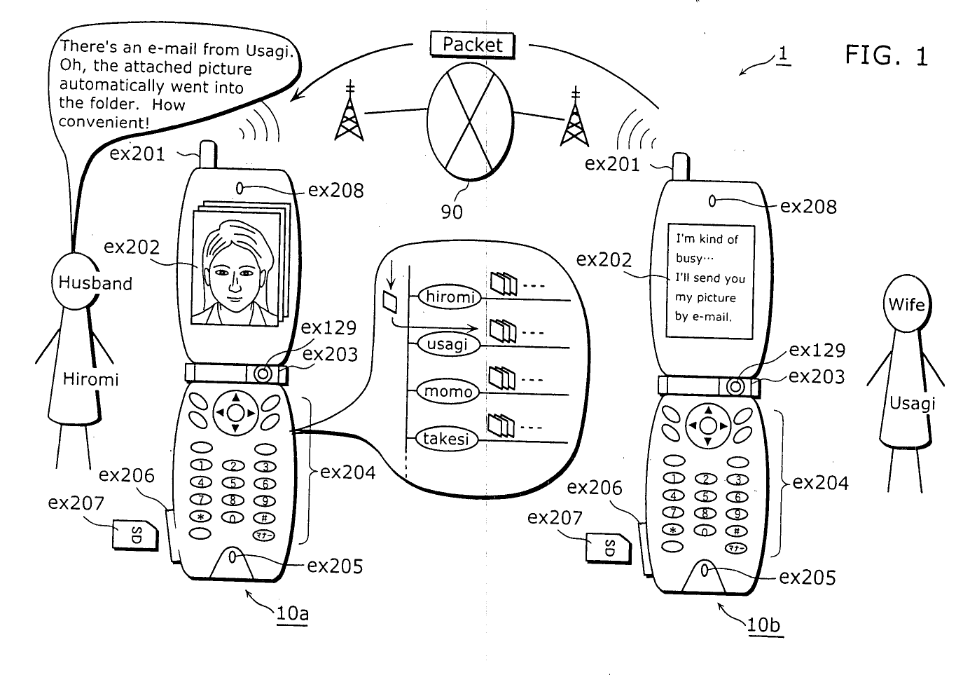

FIG. 1 is a diagram showing the overall configuration of a communications system 1 in the first embodiment of the present invention.

This communications system facilitates smoother communication by generating and reproducing a short film using an image related to the originator when there is an incoming call, and includes a plurality (2, in the diagram) of communications terminals 10a and 10b which execute packet communications via a network 90, which is a wireless transmission line.

The communications terminals 10a and 10b are respectively carried by differing users (for example, a husband, Hiromi Izumo, and his wife, Usagi Izumo), and are communications devices such as cellular phones which send/receive a variety of data in packets, such as voice, e-mail with DSP attached, and so on. The communications terminals 10a and 10b include: an antenna ex201, for sending/receiving radio waves to/from a base station; a camera unit ex203, which is able to take digital still pictures and includes a CCDex129, a flash, and the like; a main body unit, configured from an operation key ex204 group; a sound output unit ex208 for outputting music, conversation voice, and the like, configured of a speaker and so on; a sound input unit ex205 for inputting sound, configured of a microphone and the like; a recording medium ex207 for saving data of digital still pictures and the like taken with a digital camera; a slot unit ex206, to make possible the mounting of the recording medium ex207 in the communications terminals 10a and 10b; and a display unit ex202, for displaying digital still pictures and the like taken with the camera unit ex203, digital still pictures and the like received via the antenna ex201, and so on.

Note that a touch panel is mounted on the surface of the display unit ex202.

In addition, because it has become common for a user to exchange e-mails with a DSP attached using a cellular phone with an attached camera, these communications terminals 10a and 10b include a memory unit 16 in the interior of the machine. In the case where an e-mail with a digital still picture attached is received, a large number of DSP sent from the communications partner are automatically stored in a folder corresponding to the sender. In the case where there is an incoming call, a digital still picture associated with the originator is read out from a folder, and short film with BGM included is generated and reproduced. Note that here, incoming call means receiving a packet which includes various kinds of data, such as data for prompting off-hook in voice conversations, e-mail data, etc.

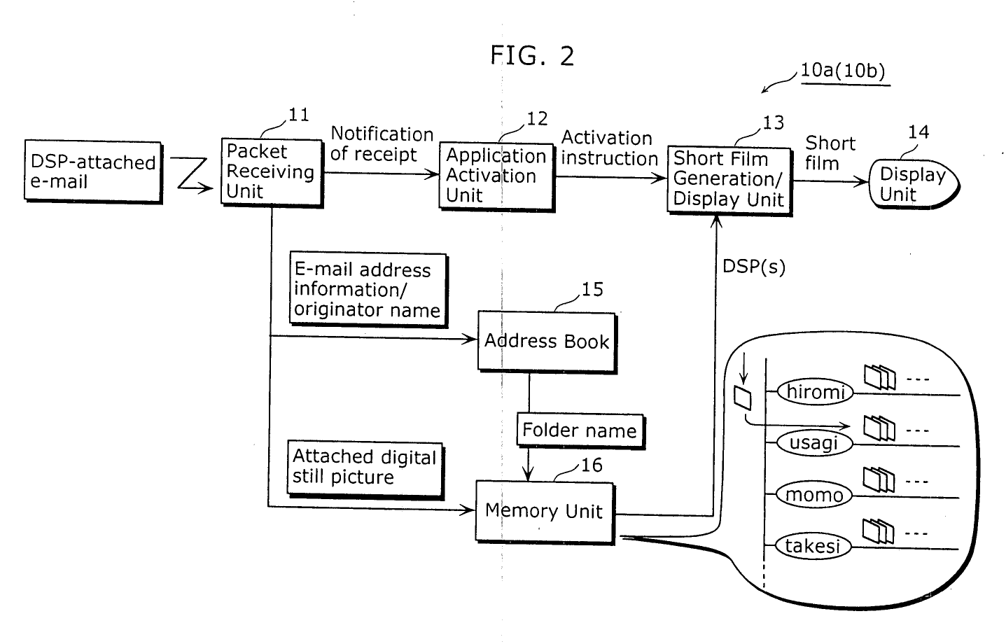

FIG. 2 is a block diagram showing the function configuration of the communications terminal as indicated in FIG. 1. Note that because the configuration of the communications terminals 10a and 10b are the same, communications terminal 10a is described as a representative. Additionally, only parts according to the function configuration associated with packet reception are illustrated.

As shown in FIG. 2, the communications terminal 10a is configured of: an incoming signal unit 11; an application activating unit 12; a short film generating/reproducing unit 13; a display unit 14; an address book 15; and a memory unit 16.

The incoming signal unit 11 is configured of the aforementioned antenna ex201, and provides a receiving interface for packets via the network 90. Additionally, when the incoming signal unit 11 receives an e-mail, it notifies the application activating unit 12 of the incoming signal, as well as passing the e-mail address of the originator of the e-mail to the address book 15.

The application activating unit 12 activates pre-registered applications in response to an input, but here, it causes the short film generating/reproducing unit 13 to activate.

The short film generating/reproducing unit 13 generates a short film including BGM using DSP stored in a folder corresponding to the originator, and immediately begins reproduction.

The display unit 14 displays the short film reproduced by the short film generating/reproducing unit 13.

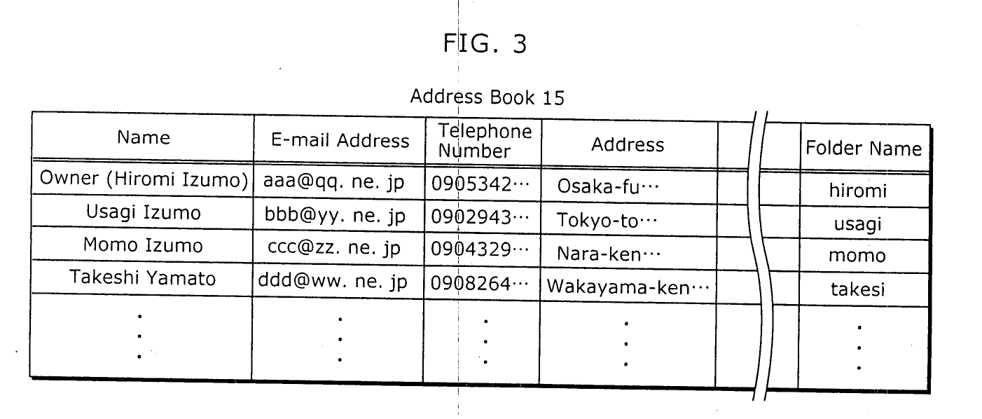

As shown in FIG. 3, the address book 15 is a type of database in which the personal data (address, name, age, telephone number, e-mail address, etc.) of the terminal owner's family, friends, and acquaintances, is stored. However, in addition to that, the address book 15 also stores a folder name which saves attached data sent by family, friends, and acquaintances. In other words, the address book 15 is configured of attributes such as name, e-mail address, telephone number, and address, in addition to a folder name associated with the sender of the packet. The folder name thus fulfills a role similar to an address, as it were, designating a domain for saving data in the memory unit 16. Through this, it becomes possible to search the address book using the originator's telephone number or e-mail address as a key, and to save attached data in a folder associated with the originator.

In the example in the diagram, the names, e-mail addresses, telephone numbers, addresses, and folder names of the following people are registered: a husband, Hiromi Izumo, who has moved to Osaka due to his job; his wife, Usagi Izumo, who has remained in Tokyo at the family house or due to her job; a daughter Momo Izumo, who lives in a dormitory at a school; and a childhood friend Takeshi Yamato. Note that the address book 15 includes a function to output the folder name that corresponds to the e-mail address of an e-mail originator when the address book 15 is passed the e-mail address in question from the incoming signal unit 11.

The memory unit 16 includes a folder registered in the address book 15. Additionally, the memory unit 16 includes a function to save an attached DSP that has been removed from an e-mail in a folder indicated by a folder name outputted from the address book 15. Additionally, the memory unit includes a function to select DSP in pluralities from folders designated by the address book 15 and output the selected digital still pictures to the short film generating/reproducing unit 13.

Next, a movement of the DSP in the case where an e-mail with DSP attached is received by the communications terminal 10a (10b) is described.

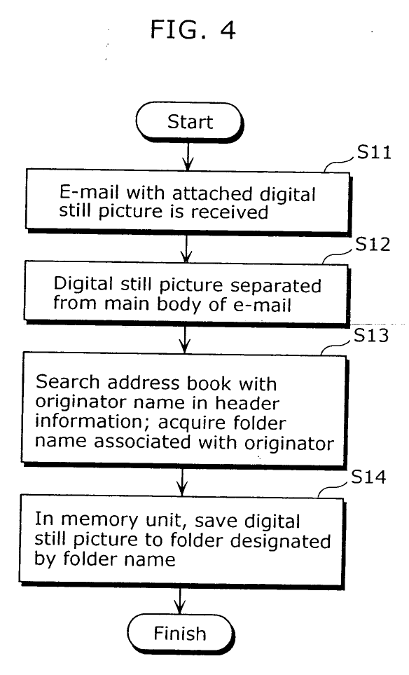

FIG. 4 is a flowchart showing a DSP storage processing executed in the case where an e-mail with a DSP attached is received.

When the incoming signal unit 11 receives an e-mail with an attached digital still picture from an e-mail server (S11), it separates the main body of the e-mail and the digital still picture (S12). Then, the incoming signal unit 11 passes the e-mail address of the e-mail's originator as a key to the address book 15, as well as passing the separated digital still picture to the memory unit 16.

The address book 15 searches the address book with the originator name in the header information passed from the incoming signal unit 11, acquires the folder name associated with the originator (S13), and outputs the folder name associated with the originator to the memory unit 16. The memory unit 16 saves the digital still picture in the folder of the folder name designated by the address book 15 (S14).

Through the above procedure, pictures taken by the originator are automatically arranged in the folder associated with the originator, and accumulate.

Next, the procedure at the time of an incoming signal is described, with the case where an e-mail is received used as an example.

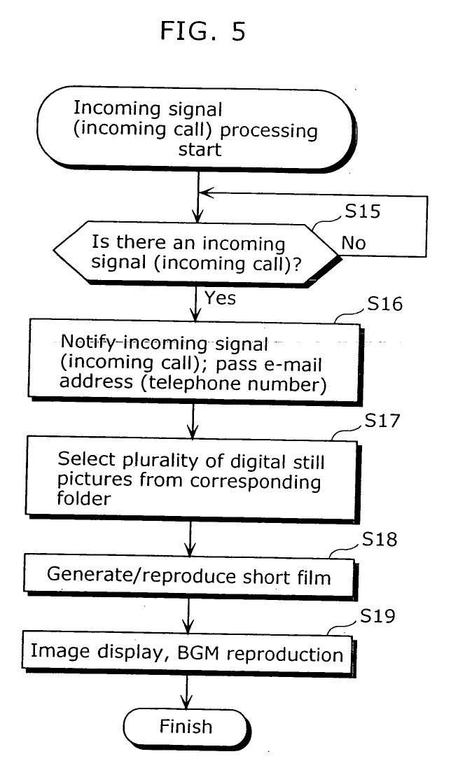

FIG. 5 is a flowchart showing incoming signal processing executed in the case where an e-mail is received. Note that the incoming call processing executed in the case where there is a telephone call is also shown in the same diagram.

When the incoming signal unit 11 receives an e-mail (Yes of S15), it notifies the application activating unit 12 of the incoming signal, as well as passing the e-mail address of the e-mail's originator to the address book 15 (S16).

When the application activating unit 12 received the notification of the incoming signal from the incoming signal unit 11, it causes the short film generating/reproducing unit 13 to activate.

On the other hand, the address book 15 outputs the folder name associated with the inputted mail address to the memory unit 16, and the memory unit 16 selects DSP in pluralities from the folder corresponding to the folder name (S17) and outputs them to the short film generating/reproducing unit 13. Here, the DSP selection rules indicate that it does not matter if the newest DSP in the folder is selected, or if a plurality is selected at random. Those DSP selection rules are acceptable as long as they are dependent on the short film generating/reproducing unit 13.

The short film generating/reproducing unit 13 generates a short film from the selected digital still pictures and music matching those digital still pictures as BGM, and reproduces the short film (S18).

The generated content, which is the short film video, is displayed in the display unit 14, and the BGM is reproduced from the sound output unit ex208 (S19). Note that here, the case where an e-mail is received was described as an example, but a short film is also generated and reproduced in the same manner for an incoming call in the case of a conversation.

Therefore, the complicated conventional operations such as setting ringtones and standby screens in advance are unnecessary, and the receipt of a voice conversation or e-mail, and the incoming call partner, can be made known through a short film which uses music and digital still pictures held in advance and which is automatically customized for each originator.

In other words, the merit of the present invention is that a user does not need to set incoming signal notification content for each originator. Using DSP accumulated through day-to-day e-mail exchange, content unique to the originator is reproduced, and the same effect can be achieved as when setting contents notifying incoming calls for each individual originator.

Note that here, a situation in which a short film is generated and reproduced was described, but causing an LED set in the communications terminal 10a (10b) to illuminate or change color in tandem with the short film reproduction is also acceptable.

In addition, a situation in which a short film in generated and reproduced was described, but in the case where there was an incoming signal, incoming call, and the like, taking only one digital still picture from the corresponding folder and displaying that digital still picture is also acceptable. In such a case, it is acceptable to take out only one digital still picture in step S17, reproduce only the digital still picture in step S18, and display only the digital still picture in step S19.

Through this as well, complicated conventional operations such as pre-setting ringtones and standby screens are unnecessary, and the receipt of a voice conversation or e-mail and the incoming call partner can be made known through a short film which uses a digital still picture held in advance and which is automatically customized for each originator.

### Second Embodiment

Next, a different communications terminal used in a communications system according to the second embodiment of the present invention is described.

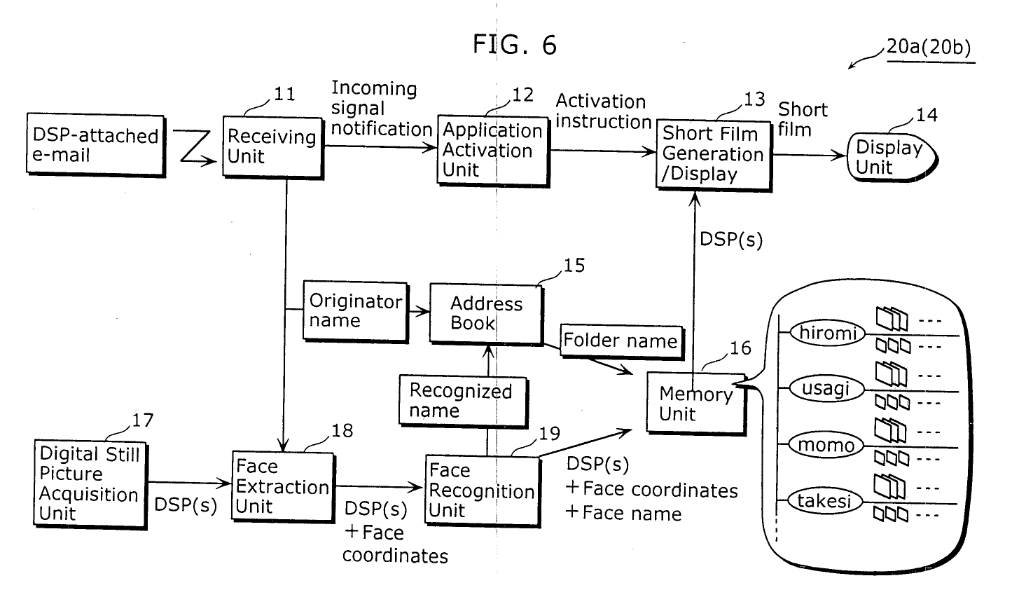

FIG. 6 is a block diagram showing a function configuration of other communications terminals 20a and 20b, used in place of the communications terminals 10a and 10b. Note that because the configuration of the communications terminals 20a and 20b are the same, communications terminal 20a is described as a representative. Additionally, only parts according to the function configuration related to packet reception are shown in the diagram. Also, the configuration parts corresponding to those in the communications terminal 10a are given the same numbers, so that description is omitted.

The communications terminal 20a includes: a receiving unit 11; an application activating unit 12; a short film generating/reproducing unit 13; a display unit 14; an address book 15; and a memory unit 16; and further includes an image acquiring unit 17; a face detecting unit 18; and a face recognizing unit 19.

Incidentally, a DSP sent from an originator does not necessarily show the originator him/herself. There is also the case where only another person is shown, a case where only a landscape is shown, and the like. When this kind of digital still picture, in which the originator him/herself is not shown, is selected as an element of a short film, a situation may arise in which it is difficult to identify the originator. Accordingly, in the case such as where there is an incoming signal of an e-mail, a configuration is employed in which the face detecting unit 18 and the face recognizing unit 19 are set so that only a photograph showing the holder him/herself of the e-mail address (originator) is selected, and information such as the position of a face in the digital still picture and the name of the face is pre-acquired.

The face detecting unit 18 searches in the image data of the DSP, identifies the area in the digital still picture where the face is showing, and extracts the coordinate values of that area. Additionally, the face detecting unit 18 identifies not only the face, but also each area where parts such as the eyes and mouth are showing, and extracts the coordinate values of those areas. The form of each area may be a square (coordinates of a first point and a last point of one diagonal of a quadrangle) or a circle (a center coordinate of the circle, and the circle's radius).

The face recognizing unit 19 determines who the face inside the designated area is, and locates that name. The determination of who the face is, is carried out through pattern matching with the pattern of the characteristics of the originator held in advance.

Note that the processing of the face detecting unit 18 and the face recognizing unit 19 is carried out, for example, between step S12 and step S13 in FIG. 4.

Then, in step S14, the aforementioned two types of data (face coordinates and face name) are associated with the digital still picture as object information, and are saved with the digital still picture in the folder in the memory unit 16 that is associated with the folder name designated by the address book 15. Note that through the face recognizing unit 19 searching the address book for the recognized name, the folder name linked with that name is acquired.

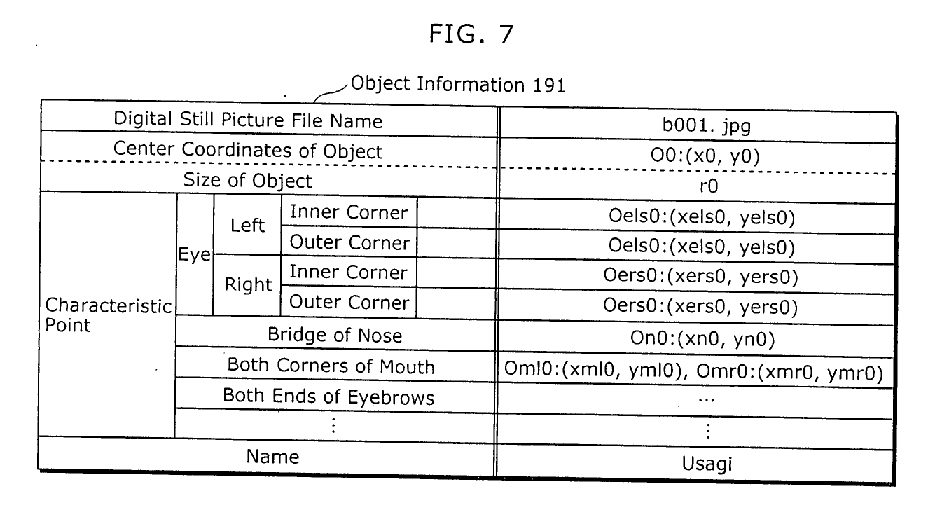

FIG. 7 is a diagram showing a configuration example of the abovementioned object information.

As shown in FIG. 7, object information 191 is configured including center coordinates of the circle the extracted object borders, position information expressed by the size of the radius, the file name of the corresponding digital still picture, in addition to characteristic points and a name. The characteristic points are position coordinates including, as mentioned above, the inner and outer corners of the eyes, the apex of the nose, both ends of the mouth, and the beginning and end of the eyebrows.

With the object information 191 configured in this manner, the object position and face characteristic points, respectively, are acquired for all digital still pictures applicable to image processing, and image processing centered around the parts of the object, image processing centered around the name, and the like, is made possible.

Note that a digital still picture is data such as EXIF which is configured as one file from header information and an image data part (a format such as JPEG), so it is also acceptable to store the object information 191 in this header information. Of course, the header information and the image data are separate files, so, even in the case where header information and picture data are in separate files and they are associated with each other through some means, such as a database and an HTML document, the object information 191 may be associated with the header information and the picture data in accordance with the format in which they are associated with each other.

An image acquiring unit 17 is configured of the abovementioned camera unit ex203 and recording media ex207, and acquires digital still pictures taken through the camera unit ex203, digital still pictures stored in the recording media ex 207, and the like. Regarding these acquired digital still pictures, no originator exists, or it is not known who is shown.

Because of this, the object information 191 is being created through the face detecting unit 18 and the face recognizing unit 19 for a digital still picture acquired through the image acquiring unit 17 as well. In this case, the name in the address book 15 is referred to from the name recognized by the face recognizing unit 19, and the digital still picture and the object information 191 are stored into the folder with the folder name of the referred name. Through this, effective usage of the photographs that the user holds can be achieved. Note that in the case where an e-mail with an attached digital still picture is received, even when the originator (for example, Momo Izumo) and the person shown in the image picture (for example, Usagi Izumo) are different, it is also acceptable to cause the picture to be stored in the folder associated with the person shown in the picture (usagi).

Through the above configuration, in the case where there is an e-mail's incoming signal, as shown in step S17 of FIG. 5, it is possible to select only a photograph showing the person him/herself (the originator) from the folder that corresponds to that e-mail address, and generate and reproduce a short film. Therefore, it is possible to reliably identify the originator from the short film.

### Third Embodiment

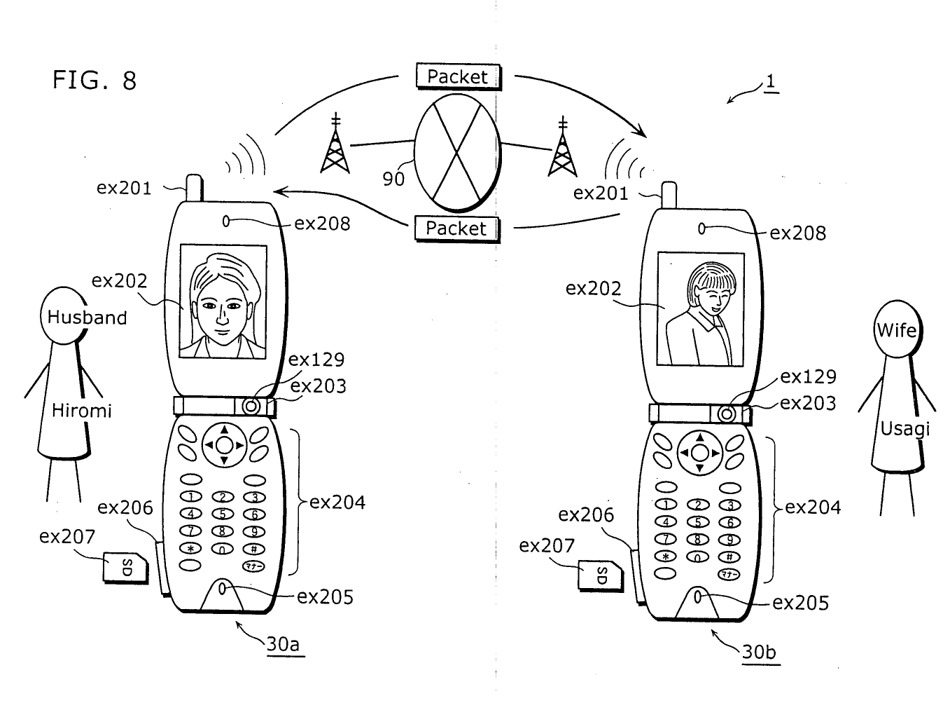

FIG. 8 is a diagram showing the overall configuration of a communications system 2 in the third embodiment of the present invention.

This communications system 2 differs from conventional communication, where intent is communicated through words and e-mail, in that it achieves smoother communication by communicating “emotions,” which cannot be put into words, through simple operation such as touching a touch panel. The communications system 2 includes a plurality (two, in the diagram) of communication terminals 30a and 30b which execute packet communications of an action corresponding to an operation via a network 90, which is a wireless transmission line.

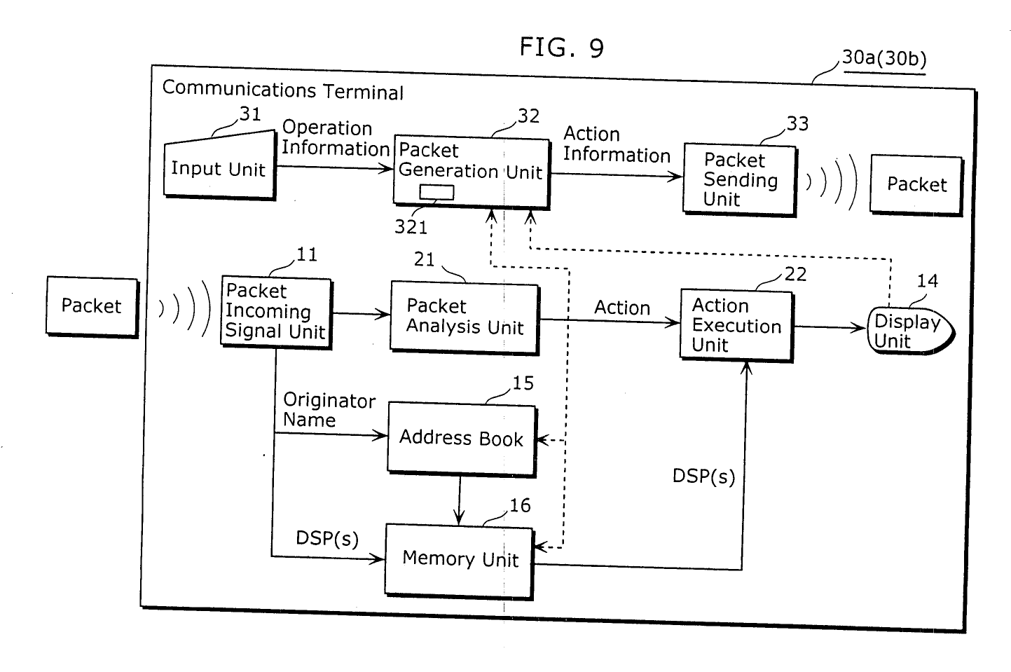

FIG. 9 is a block diagram showing the function configuration of communications terminals 30a and 30b as indicated in FIG. 8. Note that because the configuration of the communications terminals 30a and 30b are the same, communications terminal 30a is described as a representative. Also, the configuration parts corresponding to those in the communications terminal 10a and 20a are given the same numbers, so that description is omitted.

The communications terminal 30a includes: the abovementioned incoming signal unit 11; a display unit 14; an address book 15; a memory unit 16; and further includes a packet analyzing unit 21; an action executing unit 22; an input unit 31; a packet generating unit 32; and a packet sending unit 33. Note that while not illustrated here, the configuration may also include a face detecting unit 18 and a face recognizing unit 19, as shown in FIG. 6.

The input unit 31 is configured from a button group ex204, including the abovementioned touch panel, a jog dial, and the like, and accepts operations (operations information) such as tapping executed by the operator.

The packet generating unit 32 generates a packet (request packet) describing an action on the packet receiving side, from the operations received by the input unit 31. In other words, the packet generating unit 32 has an operation-action conversion table 321, and generates packets based on the operation-action conversion table 321.

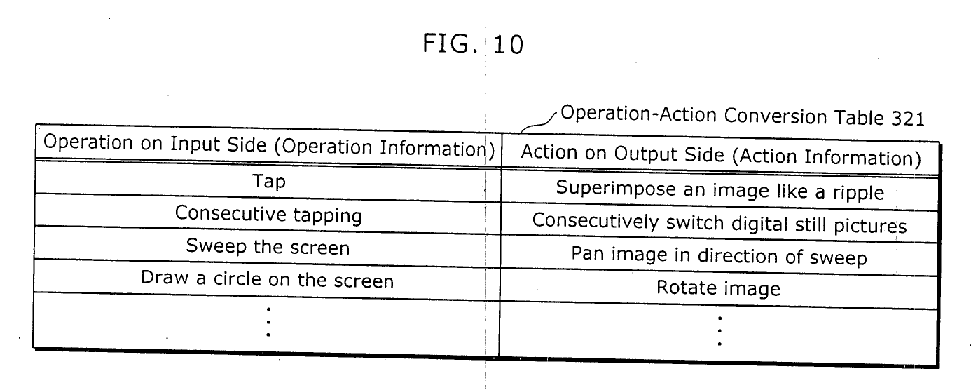

The action-operation conversion table 321, as shown in FIG. 10, regulates the relationship between the input operations and the action on the output side; for example, when the operation on the input side is a single tap only, that operation is converted into action information which executes, on the output side, an action such as superimposing an image like a ripple. Additionally, if the operation on the input side is consecutive tapping, that operation is converted to action information which displays, in the output side, three selected digital still pictures by switching them like still→still→still, or, in other words, in a slideshow manner. Also, if the operation on the input side is sweeping the screen surface, that operation is converted into action information which pans the digital still picture in the direction of the sweep on the output side. Also, if the operation on the input side is drawing a circle on the screen, that operation is converted into action information which causes the image to rotate on the output side.

Note that when the packet generating unit 32 accepts the operation information, it searches the folder in which the digital still picture displayed in the display unit 14 (standby screen) is stored, and further refers to the address book 15, acquiring the e-mail address from the folder name of the searched folder. Then, the packet generating unit 32 designates the acquired e-mail address as the destination address, and generates a packet in which the action information is stored.

The packet sending unit 33 provides an interface with the network 90.

The packet analyzing unit 21 analyses the class of the action in the received packet.

The action executing unit 22 executes the action of the class analyzed by the packet analyzing unit 21.

Next, the sense-of-connection communications carried out between the communications terminals 30a and 30b is described.

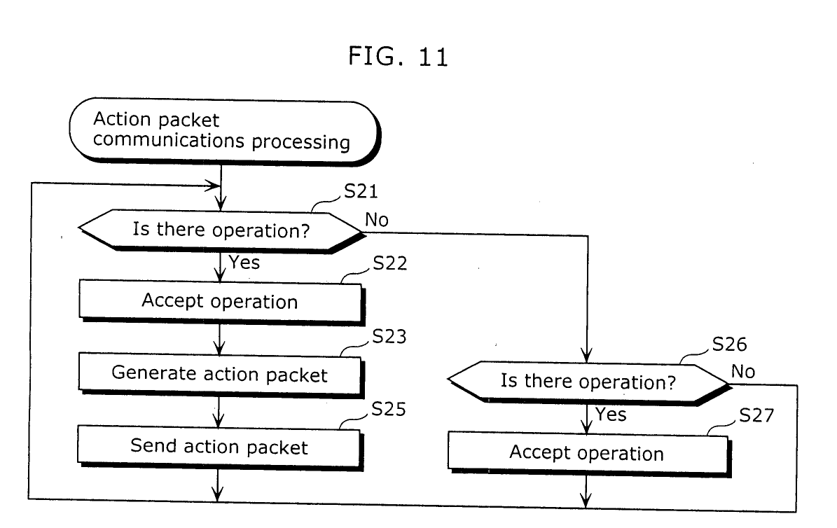

FIG. 11 is a flowchart showing action packet communications processing for realizing sense-of-connection communications as carried out between communications terminals 30a and 30b. Note that the processing in the communications terminal 30a is shown here. Additionally, description is provided assuming that a digital still picture of Usagi Izumo which is stored in a folder (for example, usagi) is displayed in the display unit 14 of this communications terminal 30a.

The input unit 31 of the communications terminal 30a waits for a finger operation, including tapping, to be executed (S21), and the packet incoming signal unit 11 waits for an action packet to be received (S26).

When there is an operation (Yes of S21), the input unit 31 accepts that operation. Then, the packet generating unit 32 generates a packet, which is data describing an action that should be carried out in a partner terminal, based on the accepted operation (S23). When the packet generation finishes, the packet sending unit 33 sends the generated packet to the partner terminal which corresponds to the digital still picture displayed in the display unit (S24).

On the other hand, in the case where there is no finger operation (No of S21), when an action packet is received (Yes of S26), the action executing unit 22 executes the action described in the received packet based on the results of the analysis of the action packet performed by the action packet analyzing unit 22 (S27). Note that in the case where a digital still picture is not displayed in the display unit at the time a packet is received, the case where a digital still picture stored in a folder differing from the packet's originator is displayed, and the like, the action described in the packet is executed on a selected digital still picture, after the digital still picture is selected from the folder corresponding to the originator.

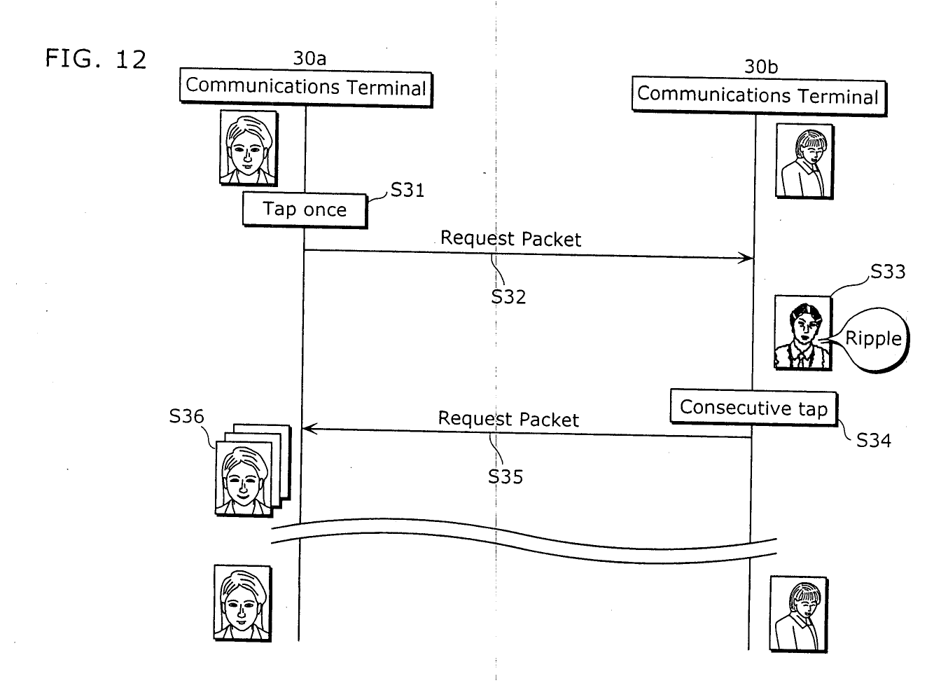

FIG. 12 is a diagram showing a communications sequence in the sense-of-connection communications carried out between communications terminals 30a and 30b.

Note that the following description assumes that the respective communications terminals 30a and 30b possessed by the husband Hiromi and the wife Usagi are in a state where they are set in their battery chargers, and are in a standby state; the husband Hiromi's communications terminal 30a displays a photograph of the wife Usagi as a standby screen, and the wife Usagi's communications terminal 30b displays a photograph of the daughter Momo as a standby screen.

The husband Hiromi taps the touch panel (input unit 31) of the communications terminal 30a once while it is in a state where the wife Usagi's photograph is shown as the standby screen (S31). The packet generating unit 32 of the communication terminal 30a generates a request packet describing the action (ripple) and the tapped area in the communications terminal 30b, and sends the request packet to the communications terminal 30b (S32). Note that that tapping occurs in the state where the wife Usagi's photograph is displayed as the standby screen, so the destination of the request packet automatically becomes the e-mail address of the communications terminal 30b.

When the packet analyzing unit 21 of the communications terminal 30b receives the request packet via the incoming signal unit 11, the packet analyzing unit 21 outputs the originator (the husband Hiromi), the action (ripple), and the touch area stored in that packet to the action executing unit 22. The action executing unit 22, having received this, selects one photograph from the folder (hiromi) which is associated with the originator of the packet (the husband Hiromi), displays that photograph in the display unit 14 as a standby screen, and superimposes an image like a ripple, which is the action, centered on the area of the screen that was touched (S33).

When the wife Usagi, who notices the display of the ripple action, consecutively taps the screen which displays a photograph of the husband Hiromi in the same way (S34), the packet generating unit 32 of the communications terminal 30b generates a request packet describing the action (consecutive switching of a digital still picture) and the tapped area in the communication terminal 30a, and sends the request packet to the communications terminal 30a (S35). Note that the husband Hiromi's photograph is tapped, so the destination of the request packet automatically becomes the e-mail address of the communications terminal 30a.

When the action executing unit 22 of the communications terminal 30a receives the request packet, the action executing unit 22 executes the action described in the packet, reproduction of a short film (slideshow), using three photographs taken from a folder (usagi) (S36). Note that the display returns to the original standby screen when the ripple action, slideshow action, and the like, finish.

Through the above steps S31 to S36, the two people, the husband Hiromi and the wife Usagi, can exchange a “simple” emotion, showing they are thinking about one another, without exchanging words (voice conversation) or text (e-mail). That kind of emotion is not something that is exchanged upon expressly establishing a communications pass (in other words, upon expressly inputting the e-mail address of a communications partner), or something exchanged by writing text, but is something that should be exchanged in a manner similar to physical contact. Communication through the present invention makes the exchange of that kind of emotion and sense-of-connection possible.

Note that the case was described in which the communications terminal 30a was tapped once and the communications terminal 30b was tapped consecutively. However, the operations in the respective communications terminals 30a and 30b are not limited to this, and it goes without saying that other operations are also acceptable, such as, for example, the communications terminal 30a being tapped three times, and the communications terminal 30b being tapped once.

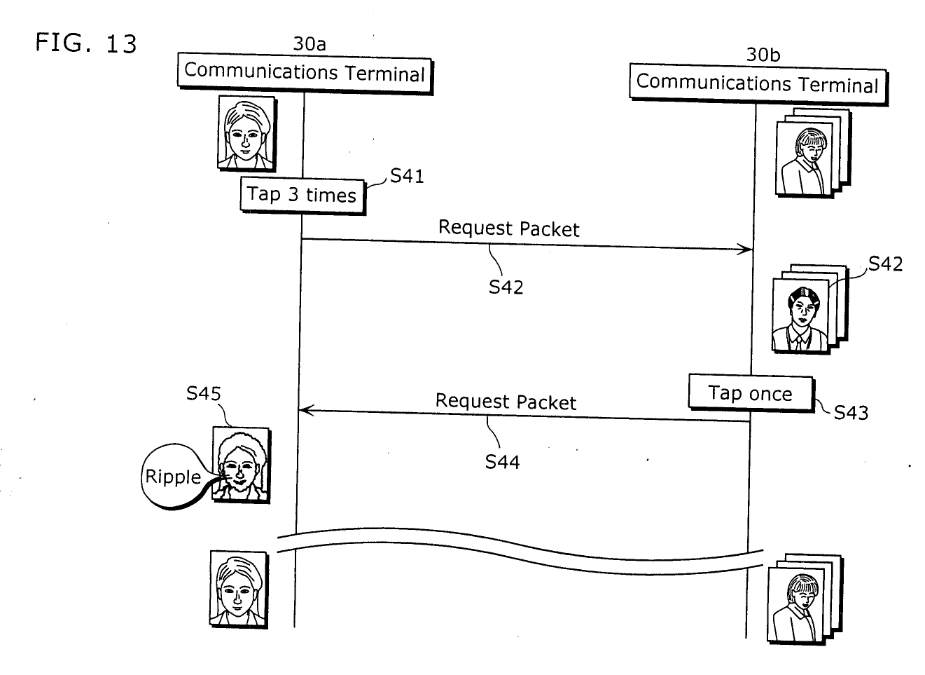

FIG. 13 is a diagram showing a communications sequence in the sense-of-connection communications carried out between communications terminals 30a and 30b, in the case where the communications terminal 30a is tapped three times, and the communications terminal 30b is tapped once. Note that the following description assumes that the wife Usagi has, at an office, set the communications terminal 30b in a battery charger to charge the battery, and reproduces a short film in that LCD using photographs of the daughter Momo, and the husband Hiromi has set the communications terminal 30a in a battery charger, and displays a photograph of the wife Usagi as the standby screen.

When the husband Hiromi taps the touch panel of the communications terminal 30a, in which the wife Usagi's DSP is displayed, three times (S41), the input unit 31 of the communications terminal 30a accepts the input from the touch panel. The packet generating unit 32 generates a request packet describing the action in the communications terminal 30a, and sends that to the wife Usagi's communications terminal 30b (S42).

The action executing unit 22 of the communications terminal 30b, which has received the request packet from the communications terminal 30a, executes the action described in the request packet. Specifically, the action executing unit 22 first searches the address book 15 using the originator husband Hiromi's e-mail address as a key, and obtains the folder name hiromi associated with the husband Hiromi. Then, the action executing unit 22 extracts three photographs from the folder hiromi of the memory unit 16 as designated by the folder name hiromi, and, using those three photographs, inserts a scene in which digital still pictures consecutively switch into a short film, and displays the short film. In other words, a short film showing the husband Hiromi is inserted in the middle of the reproduction of a short film showing the daughter Momo. When the reproduction of the short film showing the husband Hiromi ends, the display returns to the original state; in other words, returns to the reproduction of the short film showing the daughter Momo.

When the wife Usagi notices the display during reproduction of the short film showing the husband Hiromi, the wife Usagi can also return some kind of action in response to that screen. Here, this action is tapping executed once (S43). The packet generating unit 32 of the communications terminal 30b generates, in response to the input, a request packet describing the tapped area and action (ripple) in the destination (communications terminal 30a). The packet sending unit 33 then sends that request packet to the husband Hiromi's communications terminal 30a (S44).

The packet analyzing unit 21 of the communications terminal 30a, having received that request packet, analyzes the details in the pack et, and the action executing unit 22 takes, based on the analysis results, one photograph from the folder momo associated with the wife Usagi's e-mail address, displays the picture in the display unit 14, and superimposes a “ripple” on the center of the designated area.

Through the above communications method, in a time when the partner is inadvertently recalled but the exchange of words is not merited, “emotions” which cannot be put into words can be communicated to one another through simple/concise operations. Furthermore, in the communications terminal 30b, an atmosphere, in which the whole family seems to have gathered together for the first time in a long time, can be experienced.

In other words, a communication method using the terminal in the present invention provides a communication method allows both users to communicate with each other without significant mental preparation, in which a path of communications is not established, and words are not exchanged to one another, as opposed to a conventional communication method formed when words are exchanged upon the express establishment of a path of communications.

Note that in the aforementioned embodiment, the details of the operation-action conversion table 321 were stipulated as a single tap, consecutive taps, etc, as shown in FIG. 10, but in the case where the position of facial parts, eyes, mouth, etc, can be distinguished—in other words, the case where the object information 191 is present—it is also acceptable to stipulate still another action and operation in the operation-action conversion table 321.

FIG. 13 is a diagram showing still another configuration example of an operation-action conversion table.

As is shown in FIG. 13, in this operation-action conversion table 321, when the operation on the input side is tapping of an eye, the operation is converted to action information executing a winking action on the output side. Additionally, when the operation on the input side is tapping of the mouth, the operation is converted to action information executing a smiling action on the output side. Also, when the operation on the input side is sweeping of the mouth, the operation is converted to action information executing a blown kiss on the output side.

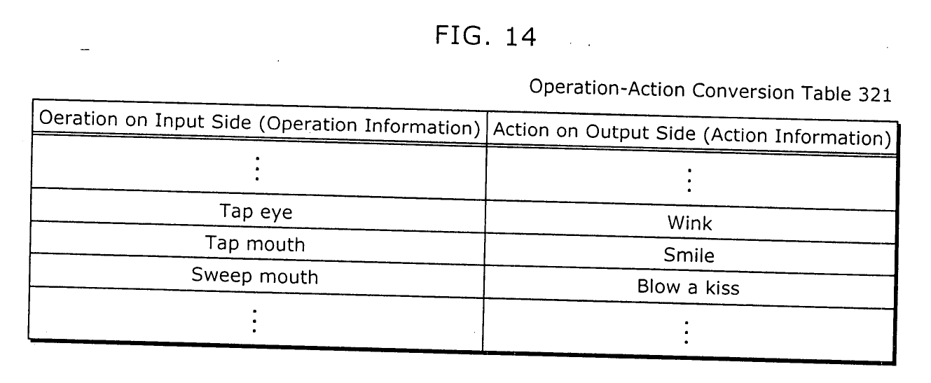

Communications with a strong sense of connection can be achieved by using the operation-action conversion table 321 configured in this manner, as shown in FIG. 14.

Next, a sense-of-connection communications executed between the communications terminals 30a and 30b is described, in the case where the operation-action conversion table 321 shown in FIG. 14 is used.

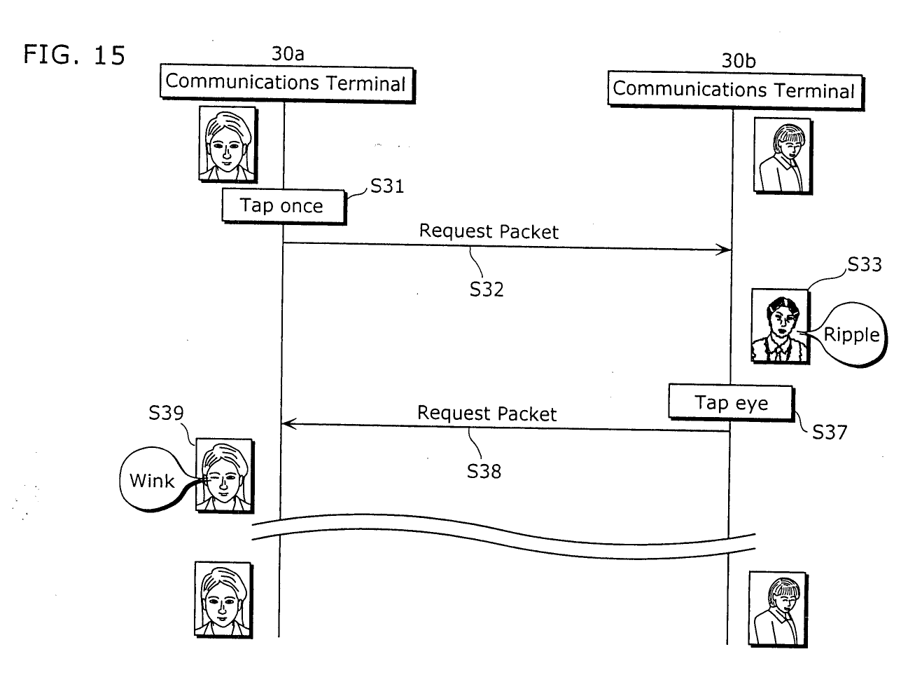

FIG. 15 is a diagram showing a communications sequence in the sense-of-connection communications carried out between communications terminals 30a and 30b. Note that here, the face detecting unit 18 and the face recognizing unit 19 are included, and the location of facial parts (eyes, nose, mouth, etc) in an image in the memory unit 16 can be recognized; and actions such as winking, smiling, and blowing a kiss can be executed on the receiving side depending on the location that is tapped.

In addition, as in the case shown in FIG. 12, the following description assumes that the respective communications terminals 30a and 30b possessed by the husband Hiromi and the wife Usagi are in a state set in battery chargers, and in a standby state; the husband Hiromi's communications terminal 30a displays a photograph of the wife Usagi as a standby screen, and the wife Usagi's communications terminal 30b displays a photograph of the daughter Momo as a standby screen.

The husband Hiromi taps the touch panel (input unit 31) of the communications terminal 30a once while it is in a state where the wife Usagi's photograph is shown as the standby screen (S31). The packet generating unit 32 of the communication terminal 30a generates a request packet describing the action (ripple) and the tapped area in the communications terminal 30b, and sends the request packet to the communications terminal 30b (S32). Note that that tapping occurred in the state where the wife Usagi's photograph was displayed as the standby screen, so the destination of the request packet automatically becomes the e-mail address of the communications terminal 30b.

When the packet analyzing unit 21 of the communications terminal 30b receives the request packet via the incoming signal unit 11, the packet analyzing unit 21 outputs the originator, the action, and the touch area stored in that packet to the action executing unit 22. The action executing unit 22, having received this, selects one photograph from the folder which is associated with the originator, the husband Hiromi, of the packet, displays that photograph in the display unit 14 as a standby screen, and superimposes an image like a ripple, which is the action, centered on the area of the screen that was touched (S33).

When the wife Usagi, who notices the display of the ripple action, taps the left eye of the screen in which the husband Hiromi's photograph is displayed (S37), the packet generating unit 32 of the communications terminal 30b generates a request packet describing the action and tapped location—in other words, the action of the left eye winking—in the communications terminal 30a, and sends the request packet to the communications terminal 30a (S35). Note that the husband Hiromi's photograph is tapped, so the destination of the request packet automatically becomes the e-mail address of the communications terminal 30a.

When the action executing unit 22 of the communications terminal 30a receives the request packet, the action executing unit 22 executes the action described in the packet

the action of causing a photograph taken from the wife Usagi's folder to wink (S39). Note that the display returns to the original standby screen when the ripple action, wink action, and the like, finish.

Through the above steps S31 to S33, S37, and S38, the two people, the husband Hiromi and the wife Usagi, can exchange a “simple” emotion, showing they are thinking about one another, without exchanging words (voice conversation) or text (e-mail). That kind of emotion is not something that is exchanged upon expressly establishing a communications pass (in other words, upon expressly inputting the e-mail address of a communications partner), or something exchanged by writing out text, but is something that should be exchanged in a manner similar to physical contact. Communication through the present invention makes the exchange of that kind of emotion possible.

### Fourth Embodiment

Next, communications terminals 40a and 40b used in a communications system according to the fourth embodiment of the present invention are described.

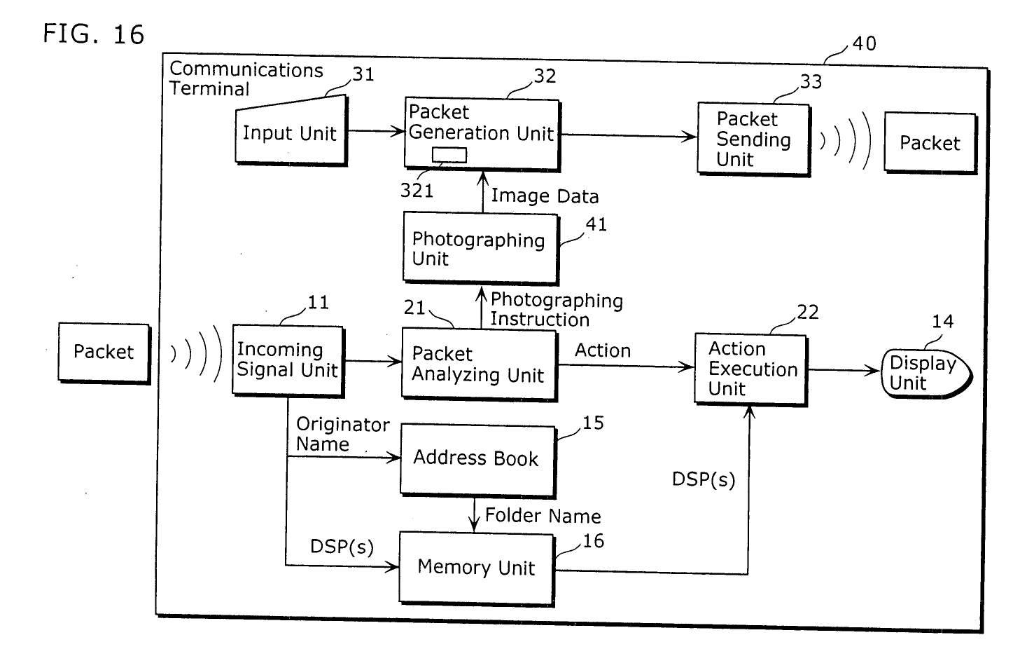

FIG. 16 is a diagram showing a function configuration of the communications terminals 40a and 40b used in a communications system in the fourth embodiment of the present invention. Note that because the configuration of the communications terminals 40a and 40b are the same, the communications terminal 40a is described as a representative. Also, the configuration parts corresponding to those in the communications terminal 10a, 20a, and the communications terminals 30a and 30b, are given the same numbers, so that description is omitted.

Like the communications terminals 30a and 30b, the communications terminal 40a achieves smoother communication by communicating “emotions,” which cannot be put into words, through simple operation such as touching a touch panel, and includes: an incoming signal unit 11; a display unit 14; an address book 15 and a memory unit 16; a packet analyzing unit 21; an action executing unit 22; an input unit 31; a packet generating unit 32; and a packet sending unit 33; and further includes a photographing unit 41. Note that while not shown here, a configuration including a face detecting unit 18 and a face recognizing unit 19, as shown in FIG. 6, is also acceptable.

The photographing unit 41 is configured of the abovementioned camera unit ex203. The photographing unit 41 executes photographing based on a photographing command from the packet analyzing unit 21, and outputs the photographed image data to the packet generating unit 32.

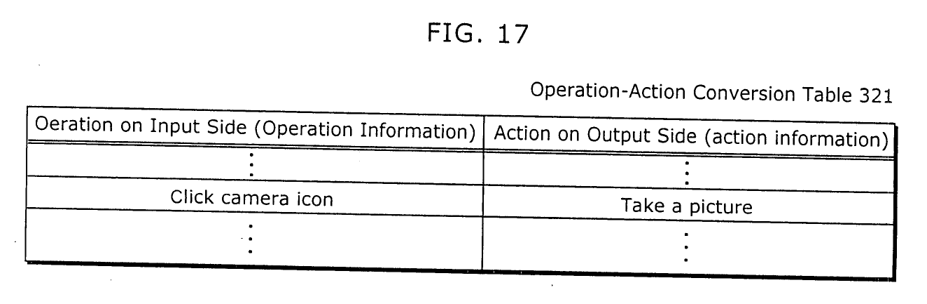

Note that an operation-action conversion table 321 held by the packet generating unit 32 further stipulates that the action of photographing should be executed on the output side when the operation on the input side is clicking a camera icon, as shown in FIG. 17.

Therefore, the packet generating unit 32 generates, in the case where the camera icon is clicked, an action packet describing an action photography, addressed to the e-mail address corresponding to the folder which includes the image displayed as the standby screen.

Next, a sense-of-connection communications, carried out between the communications terminals 40a and 40b in the case where the operation-action conversion table 321 showed in FIG. 17 is used, is described.

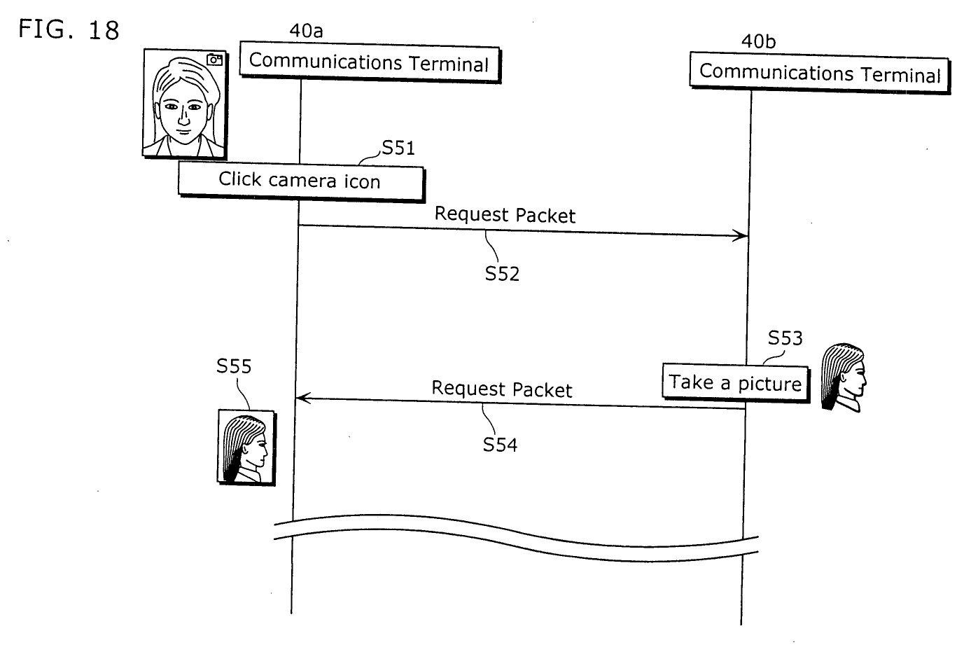

FIG. 18 is a diagram showing a communications sequence in the sense-of-connection communications carried out between communications terminals 40a and 40b. Note that here, description is given assuming the husband Hiromi displays the wife Usagi's photograph in the display unit 14 of the communications terminal 40a, and the wife Usagi displays the husband Hiromi's photograph in the communications terminal 40b. Through this, two-way communications is possible. Additionally, the camera icon is displayed in the right corner of the screen.

When the husband Hiromi, who wants to see the wife Usagi's face, clicks the camera icon on the screen (S51), the packet generating unit 32 of the communications terminal 40a generates a request packet including a photographing command; the packet sending unit 33 then sends the request packet to the wife Usagi's communications terminal 40a (S52).

The packet analyzing unit 21 of the communications terminal 40b, which receives the request packet, analyzes the packet and outputs the photographing command to the photographing unit 41. The photographing unit 41, having received the photographing command, photographs the profile of the subject, the wife Usagi (S53). The packet generating unit 32 generates a request, addressed to the communications terminal 40a, with the photographed photograph attached, and the packet sending unit 33 sends that request packet (S54).

The packet analyzing unit 21 of the communications terminal 40a, having received the request packet, analyzes the details of the packet, and the action executing unit 22 causes the attached DSP to be displayed in the display unit 14 (S55).

Through the above steps S51 to S55, the husband Hiromi can see the wife Usagi's profile without bothering the wife Usagi's work.

Therefore, the two people, the husband Hiromi and the wife Usagi, can exchange a “simple” emotion, showing they are thinking about one another, without exchanging words (voice conversation) or text (e-mail). That kind of emotion is not something that is exchanged upon expressly establishing a communications pass (in other words, upon expressly inputting the e-mail address of a communications partner), or something exchanged by writing out text, but is something that should be exchanged in a manner similar to physical contact. Communication through the present invention makes the exchange of that kind of emotion and sense of connection possible.

Note that the destination of the action packet in the aforementioned connection communications is described as an e-mail address, but a telephone number is also acceptable.

In addition, the case where the communications terminal is applied in a cellular phone is explained, but it can be applied in other communications terminals, such as personal digital assistants (PDAs); and in that connection communications, the destination of the action packet may be an address such as a unique ID assigned to that communications terminal.

In addition, to achieve the aforementioned first object, the communications terminal according to the present invention is a communications terminal which communicates with a partner terminal via a transmission line, and may include: a folder unit, which has a plurality of folders that are information recording domains and which are respectively associated with a plurality of originators; an e-mail receiving unit, which receives an e-mail attached with a file that is additional information; an e-mal originator isolating unit, which isolates an originator of a received e-mail; and a storage unit that stores the file in the folder associated with the isolated originator.

Through this, a step-by-step process of storing a file attached to a received e-mail in a folder corresponding to a predetermined originator can be omitted. Therefore, in the case where there is an incoming signal via a transmission line from a partner terminal, easily reading out a file from a folder corresponding to the originator becomes possible.

In addition, the communications terminal according to the present invention may further include: an incoming signal detection unit, which detects an incoming signal; a caller isolating unit, which isolates the caller indicated by the detected incoming signal; and a display unit, which reads out a file stored in the folder that corresponds to the isolated originator and displays the file in a screen.

Through this, it is possible to know who an originator is from a file displayed on the screen.

In addition, in the communications terminal according to the present invention, the file may include an image file that indicates an image, and the display unit may read out a plurality of image files from the folder and display a video made up of the plurality of image files read out.

Through this, it is possible to easily know who an originator is from an image file displayed on the screen.

In addition, in the communications terminal according to the present invention, the folder may include a photograph file indicating a photograph in which the originator corresponding to the folder is shown, and the display unit may read out the photograph file from the folder and display the read-out photograph file.

Through this, one can know easily and with certainty who a originator is from a photograph file indicating a photograph taken by the originator which is displayed on the screen.

### INDUSTRIAL APPLICABILITY

According to the communications terminal in the present invention, files such as music and images can simply and easily be associated with the originator, and establishing communications with a partner terminal is easy. The communications terminal has the effect of making possible active communication of feelings which arise spontaneously to a partner, and can be applied in cellular phones, personal digital assistants, personal computers with a communications function, etc.

1. A communications terminal which communicates with a partner terminal via a transmission line, said communications terminal comprising:
an input unit operable to accept a finger operation including tapping;
a packet generating unit operable to generate a packet which is data describing an action that is a procedure to be executed by a partner terminal, based on the received operation;
a transmission unit operable to transmit the generated packet to the partner terminal;
a receiving unit operable to receive the sent packet; and
an action executing unit operable to execute the action described in the received packet.

2. The communications terminal according to claim 1,
wherein, in the case where the operation is an operation in which a screen is K tapped consecutively, said packet generating unit is operable to generate a packet describing an action in which a plurality of pictures are displayed in a screen while being switched, and
said action executing unit is operable to display in a screen a plurality of pre-stored pictures while switching the pictures, when the packet is received.

3. The communications terminal according to claim 1,
wherein, in the case where the operation is an operation in which a screen is swept, said packet generating unit is operable to generate a packet describing an action in which a picture is panned in the swept direction, and
said action executing unit is operable to display in the screen a pre-stored picture while panning the picture in the assigned direction, when the packet is received.

4. The communications terminal according to claim 1,
wherein, in the case where the operation is an operation in which a circle is drawn on a screen, said packet generating unit is operable to generate a packet describing an action in which a picture is displayed while being rotated, and
said action executing unit is operable to display in the screen a pre-stored picture while causing the picture to rotate, when the packet is received.

5. The communications terminal according to claim 1,
wherein, in the case where the operation is an operation in which a screen is tapped once, said packet generating unit is operable to generate a packet describing an action in which a ripple image is displayed superimposed on a picture, and
said action executing unit is operable to display in the screen a pre-stored picture superimposed with the ripple image, when the packet is received.

6. The communications terminal according to claim 1,
wherein, in the case where the operation is an operation in which one part of a displayed picture of a person is tapped, said packet-generating-unit is operable to generate a packet describing an action in which the human picture is displayed with one part moved, and
said action executing unit is operable to display in the screen a pre-stored human picture in which one part is moved, when the packet is received.

7. The communications terminal according to claim 1,
wherein, in the case where the operation is an operation in which a screen is tapped n times, said packet generating unit is operable to generate a packet describing an action in which a video image made up of n photograph pictures is displayed, and
said action executing unit is operable to display in the screen the video image made up of n pre-stored photographs, when the packet is received.

8. The communications terminal according to claim 2,
wherein the picture is a picture showing a sender that has sent the packet.

9. The communications terminal according to claim 1,
wherein, in the case where the operation is a predetermined operation, said packet generating unit is operable to generate a packet describing an action in which a photograph is taken and returned, and
said action executing unit includes an imaging unit, and when the packet is received, said imaging unit is operable to take a photograph and to return the photograph to the partner terminal from which the packet was sent.

10. A communications method of communicating with a partner terminal via a transmission line, said communications method comprising:
an input step of receiving a finger operation, including tapping;
a packet generation step of generating a packet which is data describing an action that is a procedure to be executed by a partner terminal, based on the received operation;
a transmission step of transmitting the generated packet to the partner terminal;
a receiving step of receiving the sent packet; and
an action execution step of executing an action described in the received packet.

11. A program for a communications terminal which communicates with a partner terminal via a transmission line,
wherein said program causes a computer to execute:
an input step of receiving a finger operation, including tapping;
a packet generation step of generating a packet which is data describing an action that is a procedure to be executed by a partner terminal, based on the received operation;
a transmission step of sending the generated packet to the partner terminal;
a receiving step of receiving the sent packet; and
an action execution step of executing an action described in the received packet.

12. A computer-readable recording medium in which a program for causing a computer to execute each step according to claim 10 is recorded.
